(19) United States
(12) Patent Application Publication
(10) Pub. No.: US 2026/0103124 A1
(43) Pub. Date: Apr. 16, 2026

(54) LOCKING DEVICE FOR A MULTI-CONFIGURATION CHILD SAFETY SEAT

(71) Applicant: Evenflo Company, Inc., Miamisburg, OH (US)

(72) Inventor: Bryan Ray ADAMS, Beavercreek, OH (US)

(21) Appl. No.: 18/911,781

(22) Filed: Oct. 10, 2024

(51) Int. Cl. B60N 2/28

(52) U.S. Cl. CPC B60N 2/2821

(57) ABSTRACT

Embodiments of the present disclosure include a car seat that is convertible to adapt to different growth stages of a child from infancy to toddlerhood and beyond. The car seat has a support base and a removable seat. The removable seat has a first configuration in a first in-use configuration of the car seat where the removable seat is used in combination with the support base. The removable seat has a second configuration in a second in-use configuration where the removable seat is used on its own. The removable seat comprises one or more locking members that releasably engage with the locking structure on the support base when the removable sea is in the first use configuration.

### BACKGROUND

In the United States, child car seats are required by law and recommended for children of certain ages or sizes. There are many types of car seats available for purchase and safety requirements depend on the age and/or size of the child. For example, infants and toddlers under a certain size are recommended to be in rearward-facing car seats, and as the child is big enough, the child may sit in a forward-facing seat. Still further, as the child grows, the child may transition to a booster seat with a vehicle belt positioner and back rest or even a booster seat without a back rest. A single car seat that can convert between these different modes of use as the child grows reduces the cost of having to buy separate seats for each stage and reduces waste.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

FIGS. 1A, 1B, and 1C are a front view, a side view, and a perspective view, respectively, of a child safety seat with multiple configurations, in accordance with aspects disclosed herein;

FIG. 2 is an exploded view of a support base and a removable seat of the car seat of FIGS. 1A-1C in accordance with aspects disclosed herein;

FIGS. 3A-3D provide various views of a removable seat of the car seat of FIGS. 1A-1C, in accordance with aspects herein;

FIGS. 4A shows a perspective views of a bottom side of the removable seat in a first configuration where the supporting members are in a storage position, in accordance with aspects disclosed herein;

FIGS. 4B shows a perspective views of the bottom side of the removable seat in a second use configuration where the supporting members are in a use position, in accordance with aspects disclosed herein;

FIG. 5 is a left side view of the removable seat having supporting members in a second use configuration, in accordance with aspects herein;

FIG. 6A is a cross-sectional left side view of the removable seat only as shown in FIGS. 3A-3D and 4A in a first configuration where the supporting members are in a storage position, in accordance with aspects disclosed herein;

FIG. 6B is a cross-sectional left view of the removable seat only shown in FIGS. 4B and 5 in a second use configuration where the supporting members are in a use configuration, in accordance with aspects disclosed herein;

FIG. 6C is a cross-sectional left side view of the car seat shown in FIGS. 1A-1C with the removable seat coupled to the support base, in accordance with aspects disclosed herein;

FIG. 7A is a top perspective view of locking members and a release handle of the removable seat in accordance with aspects disclosed herein;

FIG. 7B is a bottom perspective view locking members and the release handle of the removable seat in accordance with aspects disclosed herein;

FIG. 8 provides a front perspective view and magnified detail of the support base of the car seat of FIGS. 1A-1C in accordance with aspects disclosed herein;

FIG. 9 provides a view of the support base of FIG. 8 but with external structures removed to show aspects of the frame including a receiving locking structure. in accordance with aspects disclosed herein;

FIG. 10A is a perspective view of the support base with parts removed to show the locking mechanism of the removable seat in an engaged position with the receiving locking structure of the support base, in accordance with aspects disclosed herein; and

FIG. 10B is a perspective view of the support base with parts removed to show the locking mechanism of the removable seat in a disengaged position with the receiving locking structure of the support base in accordance with aspects disclosed herein.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

It should be noted that some of the terms used herein may be relative terms. For example, the terms “upper” and “lower” and the terms “forward” (or “front”) and “rearward” (or “rear” or “back”) are relative to each other in location, i.e., an upper component is located at a higher elevation than a lower component in a given orientation, but these terms may change if the device is flipped. An intermediate component, on the other hand, is always located between an upper component and a lower component regardless of orientation. The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” are used to refer to surfaces where the top is always higher than the bottom relative to an absolute reference, i.e. the surface of the earth when the component is used as intended. The terms “upwards” or “upwardly” and “downwards” or “downwardly” are also relative to an absolute reference; upwards is always against the gravity of the earth. The terms “forward” and “rearward” or “rear” with respect to a position or orientation are opposite one another along a common direction, and an “intermediate” position is always located between a forward position and a rearward position.

The terms “operative to” and “configured to” and similar terms are used herein to describe that a particular component has certain structural features designed to perform a designated function. Such components should be construed as having the expressed structure, with the designated function being considered part of the structure. As used herein and as will be appreciated by those skilled in the art, the term “car seat” encompasses car seats, safety seats, restraints, boosters, and the like for children, infants, toddlers, and the like.

Unless indicated otherwise, all measurements provided herein are taken when a component(s) is at standard ambient temperature and pressure (298.15 K and 100 kPa). As used herein, the terms “substantially” and “about” mean within ± 5% of an indicated value.

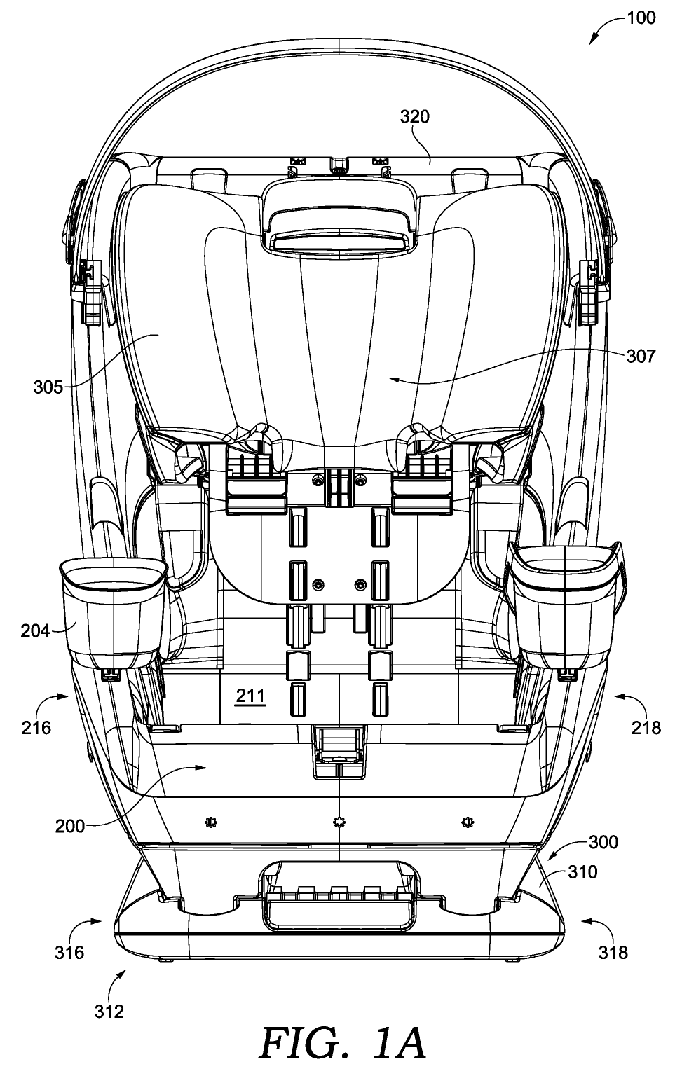

In accordance with aspects of the disclosure, aspects of car seats are illustrated in various levels of specificity in FIGS. 1A-10B. As will be appreciated by those skilled in the art, the car seats described herein may be car seats that are convertible between at least two configurations. For example, a car seat described herein may be convertible between a first configuration in which the car seat includes a seat with a back portion and a second use configuration in which the car seat includes a seat without a back portion. Further, in some examples, the car seat, when in the first configuration, may be used in a forward-facing configuration and a rearward-facing configuration. In such an example, a car seat described herein is convertible between a forward-facing configuration, a rearward-facing configuration, and a booster configuration. In yet another example, a car seat described herein is convertible between a forward-facing configuration and a rearward-facing configuration, a high-back booster configuration, and a backless booster configuration. The car seats of the present disclosure may be configured to support an infant, toddler, child, or the like.

FIGS. 1A, 1B, and 1C depict a car seat 100 designed for safely transporting an infant or child in a vehicle, such as a car. Particularly, FIG. 1A depicts a front view of the car seat 100, FIG. 1B depicts a first “right” side view of the car seat 100, and FIG. 1C depicts an angled perspective front view of the car seat 100. The car seat 100 generally includes a removable seat 200 and a support base 300 that supports the removable seat 200, for example, when installed into a vehicle. The support base 300 may include a seat portion 310 having a front end 312, a rear end 314, and a back portion 320 extending upward from the rear end 314 of the seat portion 310.

As described further herein, the removable seat 200 is operative to releasably couple to the support base 300 such that the removable seat 200 may be used on its own without the support base 300 in some configurations. Thus the car seat 100 can be used in multiple, distinct configurations. As further discussed herein, the removable seat 200 can be coupled to the support base 300 and used in combination in a first configuration of the car seat, or the removable seat 200 can be decoupled, separated from, and used in the absence of the support base 300, in a second configuration of the car seat 100. In the first configuration, the car seat 100 operates as a high-back car seat, while in the second configuration, the car seat 100 operates as a backless booster seat, for example.

For example, the car seat 100 is shown in the first configuration in FIGS. 1A, 1B, and 1C such that the removable seat 200 is shown as coupled to the support base 300, and the support base 300 is shown as positioned directly on the vehicle’s seat surface. In the first configuration, the car seat 100 may be used in a manner that an infant would be rearward-facing or a toddler would be forward facing, for example, when the car seat 100 is installed and used with a five-point safety belt harness (not shown in the figures for simplicity). In the first configuration, the removable seat 200 may be positioned on top of the seat portion 310 of the support base 300. As such, the removable seat 200 may provide a seating surface (shown as top surface 211) for supporting a seated occupant in any of the configurations discussed herein. The back portion 320 of the support base 300 may include a headrest 305 that is configured to support the occupant’s head. In some aspects, the headrest 305 may be adjustable along the length of the back portion 320 to safely accommodate occupants of different heights. In other aspects, the headrest 305 may be non-adjustable along the length of the back portion 320. In aspects, the car seat 100 may include armrests 202 on opposite sides, respectively referred to as a first “right” right and second “left” side, with respect to the occupant’s viewpoint. Accordingly, for simplicity, the occupant’s right arm would rest upon a right side armrest, and the occupant’s left arm would rest upon a left armrest, when in the car seat 100 is in a forward-facing orientation so that the occupant is facing forward with respect to the vehicle in which the car seat 100 is placed. The armrests 202 may extend upward from the removable seat 200 as illustrated herein; alternatively, the armrests 202 may extend upward from the seat portion 310 of the support base 300. In some aspects, one or both armrests 202 may include a cup holder 204, which may be removable from the armrest(s) 202, or non-removable fixed thereto.

It should be understood that, although not shown in the figures to avoid obscuring the features being discussed, the car seat 100 may include softgoods (e.g., textile coverings and/or cushioning elements) upon any occupant-supporting or occupant-contacting surface so as to support the occupant’s bottom, back, and head are comfortably supported, for example. In one example, softgoods may extend over the top surface 211 of the removable seat 200, along the front side 307 of the back portion 320 of the support base 300, along the headrest 305, and the like. Also, the car seat 100 may include one or more safety belts, such as shoulder and thigh belts and a crotch belt connected with a five-point harness, to secure an occupant safely within the car seat 100, though not shown herein to avoid obscuring the features being discussed. As mentioned, in the first configuration, the car seat 100 may operate as a high-back car seat, for example, so that a five-point harness is utilized to secure the occupant therein according to weight and height requirements. In the second configuration, the car seat 100 may operate as a backless booster seat, for example, such that a five-point harness may be removed and stowed so that the occupant is secured in the car seat 100 using a shoulder-and-waist safety belt, according to weight and height requirements.

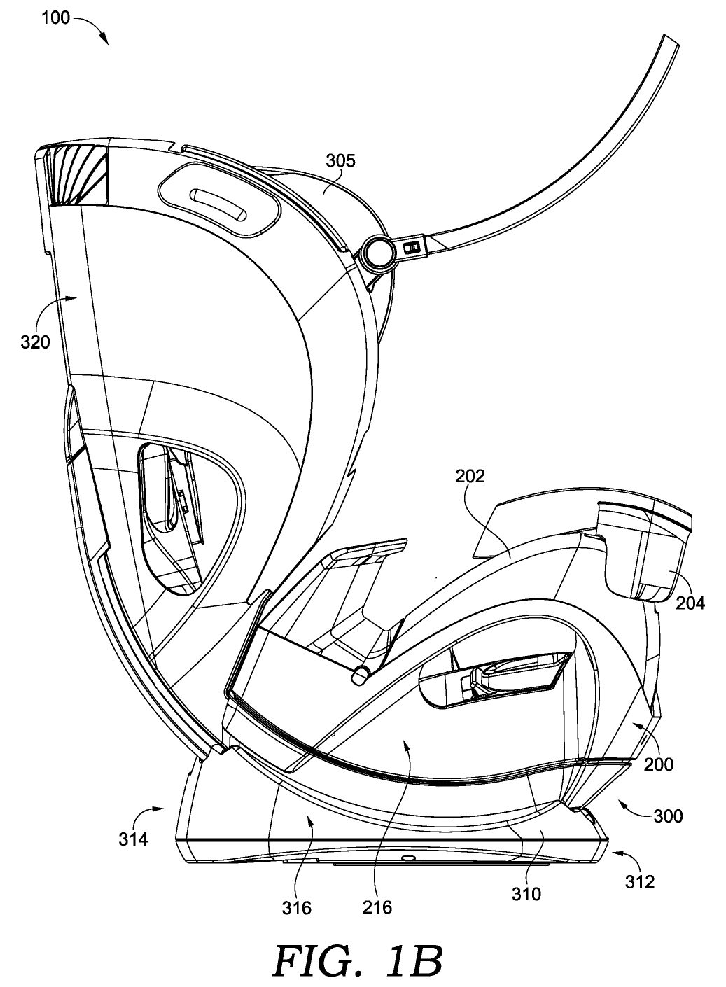

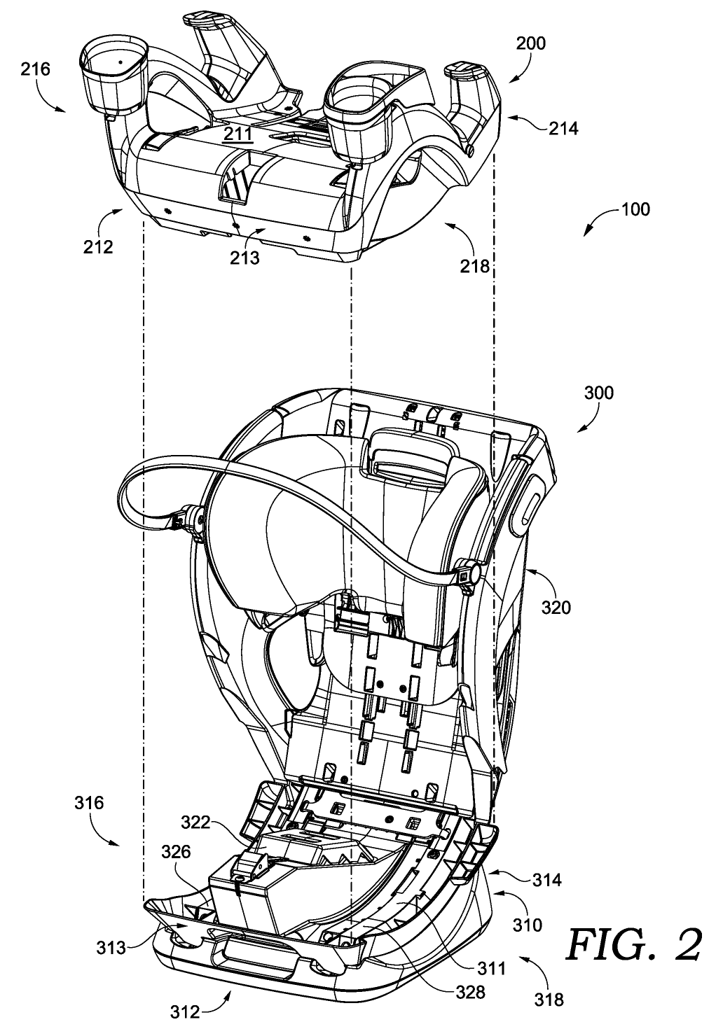

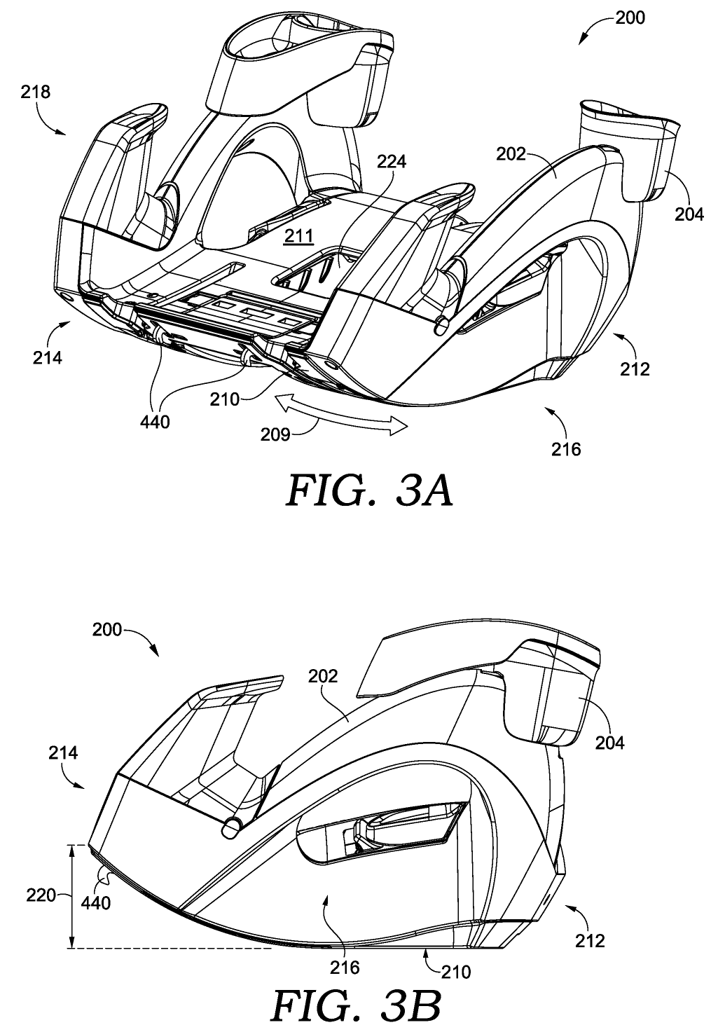

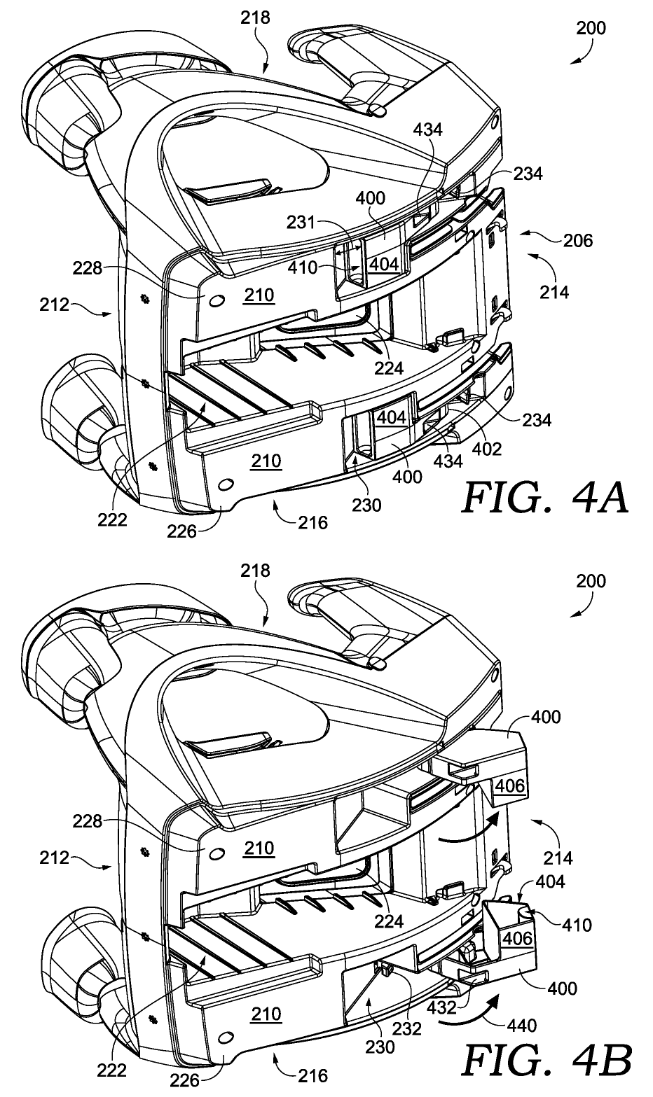

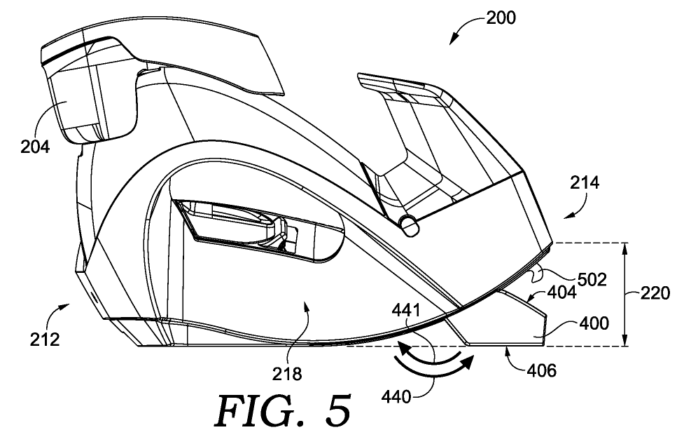

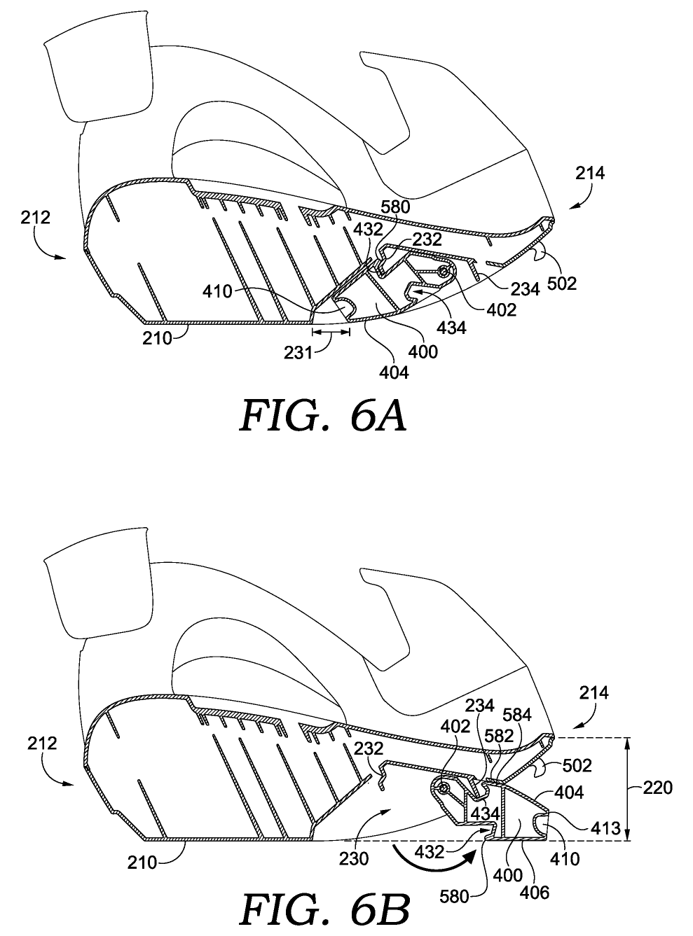

Continuing, FIG. 2 depicts an exploded view of the car seat 100, which shows the removable seat 200 as uncoupled from the support base 300. As comparatively shown between FIGS. 1C and the exploded view of FIG. 2, the first side 216 and a second side 218 of the removable seat 200 generally correspond to a first side 316 and second side 318 of the support base 300. Also, the front end 212 of the removable seat 200 is in alignment with the front end 312 of the seat portion 310 of the support base 300 when coupled together, in a first configuration. Similarly, the rear end 214 of the removable seat 200 is in alignment with the rear end 314 of the seat portion 310 of the support base 300 when coupled together, in a first configuration. As a result, a front surface 213 of the removable seat 200 is contoured so that the front surface 213 transitions into a front surface 313 of the seat portion 310 of the support base 300, when in the first configuration. Briefly looking to the side cross-section of the car seat 100 in the first configuration shown in FIG. 6C, the front surface 213 transitions into the front surface 313 such that a portion of the front surface 213 contacts an interior of a lip 586 of the support base 300 that aids in retaining the removable seat 200 within the support base 300, and prevents the removable seat 200 from sliding forward off the support base 300, for example, due to a rear impact in a vehicular crash. The substantially smooth contouring of the interlocking surfaces also ensures the comfort of the occupant’s legs as they dangle over the front surface 213. The contouring of the front surface 213 is also visible in the angled perspective view of the bottom of the removable seat shown in FIGS. 4A and 4B.

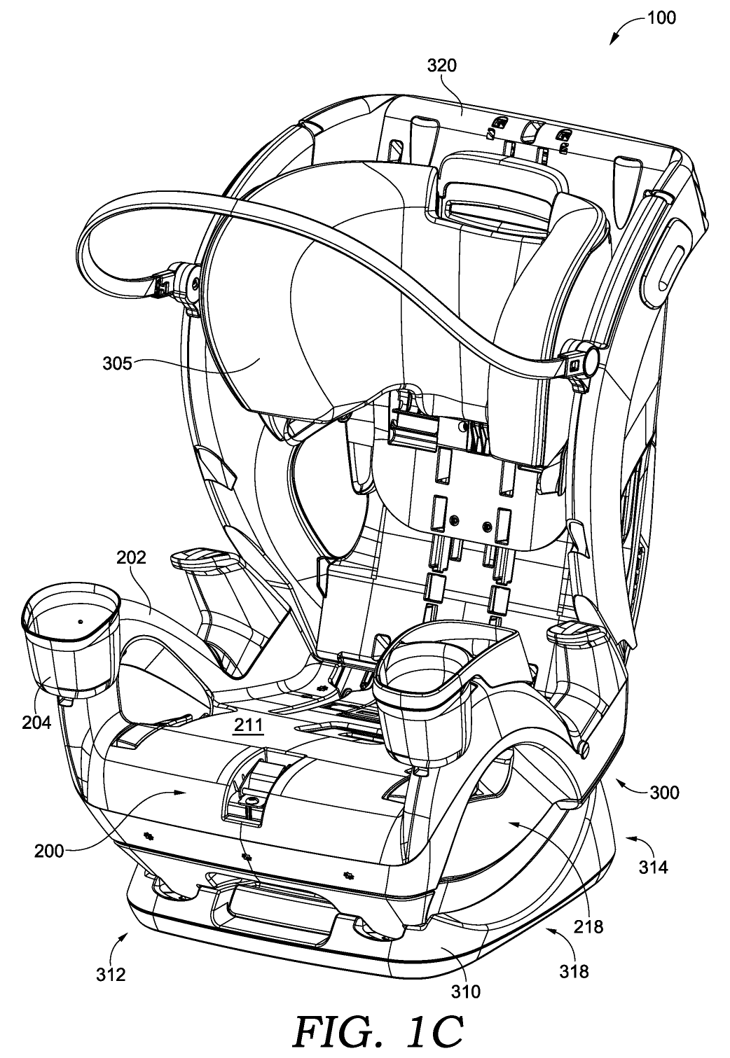

In the angled perspective, rear view of the removable seat 200 shown in FIG. 3A, the right side view of the removable seat 200 shown in FIG. 3B, the left side view of the removable seat 200 shown in FIG. 3B. Thus, based the view shown in FIGS. 1B, 2, 3A-C, 4A-B, and 6, the removable seat 200 is shaped and contoured so that it may snugly fit into and abut various portions of the support base 300 in the first configuration. For example, the lower portions and lower surfaces of the removable seat 200 may be sized, positioned, and shaped to fit with the upper portions and upper surfaces of the support base 300.

Continuing, the removable seat 200 has a bottom surface 210 as shown in the bottom view of FIG. 3D and the angled perspective views of FIGS. 4A to 4B. The bottom surface 210 is generally positioned to be opposite the top surface 211, and extends from a front end 212 to the rear end 214. The bottom surface 210 is oriented to face or contact the seat portion 310 of the support base 300 when the removable seat 200 is coupled to the support base 300 in the first configuration. At least a portion of the bottom surface 210 abuts the seat portion 310 of the support base 300 when in the first configuration, and at least portions of the bottom surface 210 of the removable seat 200 abut the vehicle seat when the car seat 100 is in the second use configuration. It should be understood from FIGS. 4A and 4B that the bottom surface 210 may have any quantity of surfaces at different elevations, angled, and/or contours.

As shown in the various views provided at FIGS. 3A-3D and 4A-B, the removable seat 200 is uncoupled and unattached from the support base 300, so that the removable seat 200 is configure to be positioned directly on a vehicle seat surface, such that the car seat 100 is in a second configuration (i.e., the removable seat 200 is used without the support base 300). In the second configuration, at least a portion of the bottom surface 210 is configured to be in direct contact with the vehicle seat surface(s), such that the removable seat 200 may be utilized alone as a backless booster seat.

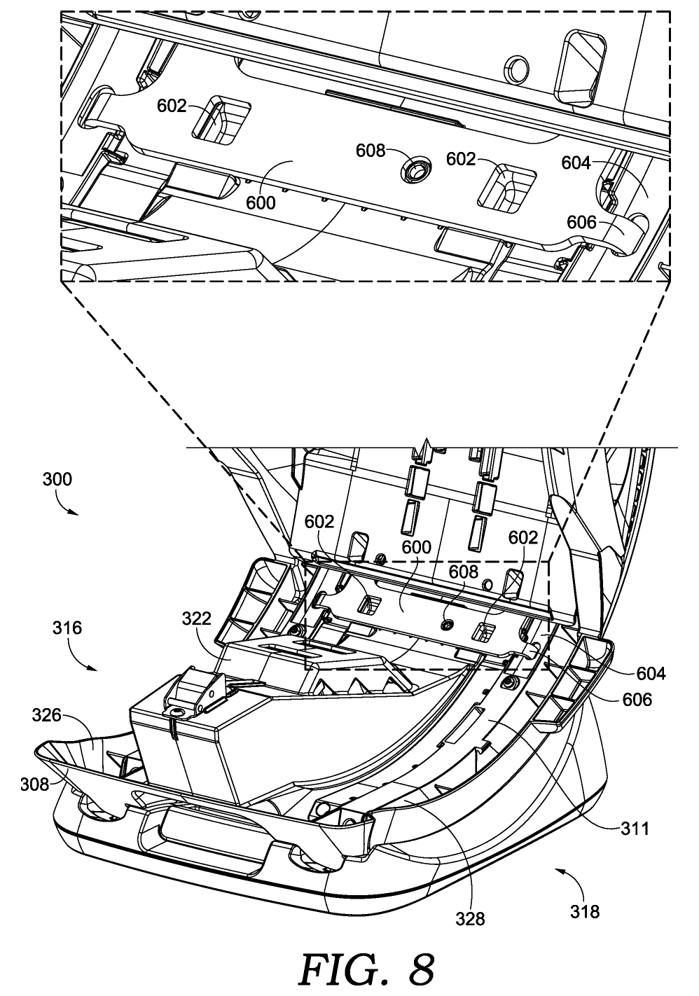

The upward curve 208 shown as an arrow in FIG. 3A of the bottom surface 210 of generally follows the contouring and curve of the seat portion 310 of the support base 300 as the seat portion 310 transitions to the back portion 320. The bottom surface 210 of the removable seat 200 may be recessed in the center between a first bottom portion 226 and a second bottom portion 228 of the bottom surface 210. The recess 222 is positioned between the first and second bottom portions 226 and 228, and as such, may accommodate a pylon 322, that is visible in FIG. 8), that projects upward from the support base 300, when in a first configuration. In some examples, the recess 222 is the only recess in the bottom surface 210 that receives a projecting member of the support base 300 when the car seat 100 is in a first configuration. Alternatively, the bottom surface 210 may include a plurality of recesses, at least a portion of which are configured to receive a projection or protrusion of the support base 300 when the car seat 100 is in the first configuration. The opening 224 may extend from the bottom surface 210 upward and through the removable seat 200 to form an opening 224 at the top surface 211. The opening 224 may provide access to a crotch-positioned belt for a five-point harness. When the car seat 100 is in the second use configuration, the opening 224 in the top surface 211 may be covered by softgoods or rigid materials, in some aspects.

Generally, the first bottom portion 226 and the second bottom portion 228 shown in FIGS. 4A and 4B are positioned to align with and/or have a flush contact the first seat portion 326 and a second seat portion 328, as shown in the exploded view of FIG. 2. The upward curve 208 of the bottom surface 210 allows for a flush interaction between the removable seat 200 and the seat portion 310, and further, aesthetically pairs the shape of the removable seat 200 with the seat portion 310 when in the first configuration. In either of the first and second use configurations however, at least a portion of the bottom surface 210 extends from the front end 212 to the rear end 214, and curves upward so that the rear end 214 of the bottom surface 210 is elevated or “higher” than the front end 212. That is, in the first configuration, the bottom surface 210 at the rear end 214 may be positioned superior to the bottom surface 210 at the front end 212. The elevation difference 220 between the bottom surface 210 at the rear end 214 and the bottom surface 210 at the front end 212 may be at least about 5 centimeters (i.e., the bottom surface 210 at the rear end 214 is superior to the bottom surface 210 at the front end 212 by at least about 5 centimeters). For example, the bottom surface 210 of the removable seat 200 at the rear end 214 is positioned at least 5 centimeters superior to the bottom surface 210 at the front end 212 when in the first configuration. The elevation difference 220, shown in FIGS. 3B and 3C, may be within a range from about 5 centimeters to about 10 centimeters in some examples. In some examples, the elevation difference 220 may be within a range from about 6 centimeters to 8 centimeters. In one aspect, the elevation difference 220 is about 7.3 centimeters. Independent of the configuration of the car seat 100, the superior positioning of the rear end 214 relative to the front end 212 is maintained. For example, when the removable seat is in the second use configuration, the bottom surface 210 of the removable seat 200 at the rear end 214 is positioned superior to the bottom surface 210 at the front end 212.

In a first configuration, the dimensions, size, and shape of the bottom surface 210 at the rear end 214 may be positioned superior to the bottom surface 210 at the front end 212, by elevation difference 220, when the front portion of the bottom surface 210 is in direct contact and parallel to a vehicle surface. In a second configuration, the support base 300 is shaped and sized to ensure that at least a portion of the elevation difference 220 is maintained when the removable seat 200 is placed and secured into the support base 300, where the support base directly contacts a vehicle’s seat, as previously shown. The elevation difference 220 is maintained because, when an occupant is seated in the car seat, the elevation difference 220 produces a reclining angle the safety supports the head, neck, and spine of the occupant in a neutral alignment with one another, whether at rest or during impact (e.g., vehicle collision, hard braking), when in either of the first or second use configurations.

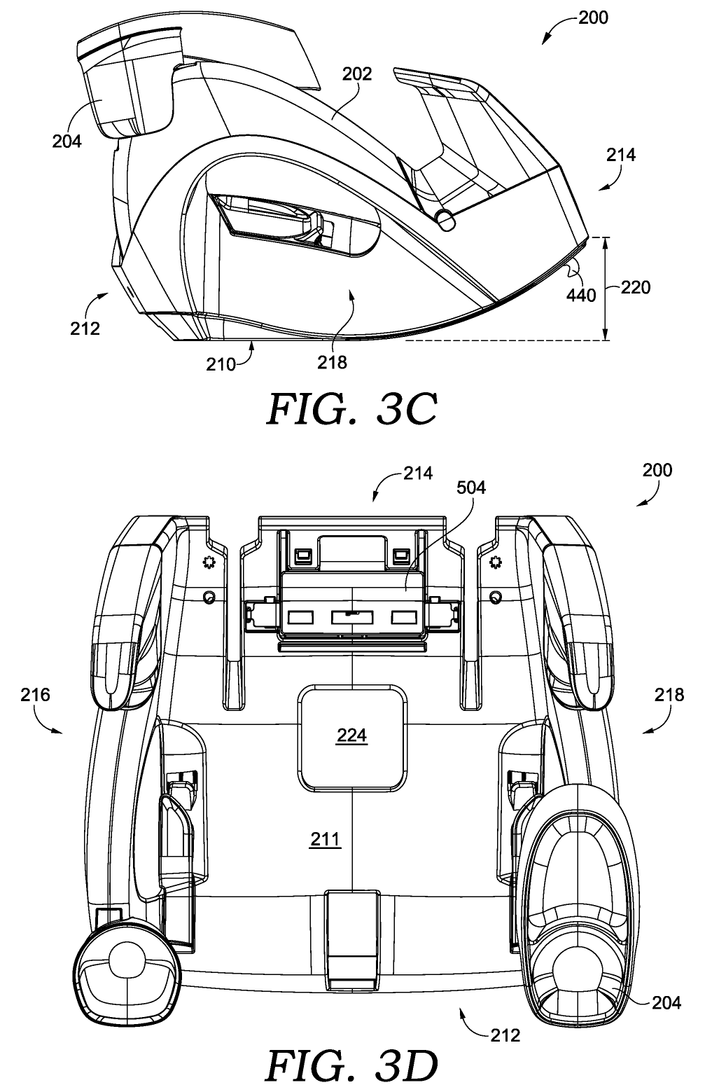

Additionally, the elevation difference 220 is specifically selected to allow one or more supporting members 400 to be repositioned from a storage position shown in FIG. 4A into a use configuration shown in FIG. 4A. In the second configuration, one or more supporting members 400 of the removable seat 200 may be moved from a storage position that corresponds to the car seat 100 being in the first configuration to a use position supporting the rear end 214 of the removable seat 200 when the car seat 100 is in the second configuration. As shown in FIG. 5, the one or more supporting members may be moved downward in a swinging motion (e.g., shown as counterclockwise) to be deployed from storage to use. When the supporting members 400 are in the use position, a second surface 406 of the supporting members 400 may be generally aligned with the bottom surface 210 at the front end 212 of the removable seat 200. In other words, the second surface 406 of each of the supporting members 400 deployed at the rear end 214 may be parallel to the bottom surface 210 at the front end 212 of the removable seat 200, so that the bottom surface 210 and the second surface 406 of each of the supporting members 400 directly contact the vehicle seat. Thus, when in the second use configuration and the one or more supporting members 400 are in the use position, a second surface 406 of each supporting member 400 abuts the vehicle seat surface. In this way, when the car seat 100 is in the second use configuration, the removable seat 200 may be placed generally level on a vehicle seat so that it is supported by the bottom surface 210 of the front end 212 of the removable seat and the second surface 406 of the supporting members 400.

For example, the removable seat 200 may have a plurality of supporting members 400. The plurality of supporting members 400 are depicted in as folded “up” into a storage position in FIGS. 4A and the cross-section view of the removable seat 200 in 6A. The plurality of supporting members 400 are depicted as folded or flipped “out” into a use position in FIGS. 4B and the cross-section of the removable seat 200 in 6B. Each of the plurality of supporting member 400 may be pivotally secured to the bottom side 206 of the removable seat 200 so that the plurality of supporting members 400 are pivotable from the storage position in FIGS. 4A and 6A to the use position in FIGS. 4B and 6B. As such, each of the supporting members 400 pivots about a corresponding pivot point that is rearward of their respective supporting-member recess 230.

The supporting members 400 may be pivotally connected to the bottom side 206 of the removable seat 200 adjacent the rear end 214 of the removable seat 200. As such, the supporting members 400 may support the rear end 214 of the removable seat 200 when pivoted outward, to convert the car seat 100 from the first configuration to the second configuration. Notably, when the plurality of supporting members 400 are placed into a use configuration such that the car seat 100 is in the second use configuration, the plurality of supporting members 400 are shaped and sized to accommodate for and/or span the elevation difference 220. Thus, in the second use configuration, the plurality of supporting members 400 stabilize the rear end 214 of the removable seat 200 as directly contacting the vehicle seat when in the absence of the support base 300. In other words, the elevation difference 220 that is supported by the support base 300 in the first configuration is maintained by the supporting members 400 when in the second configuration.

When the supporting members 400 are in the storage position, each of the one or more supporting members 400 may be received within and held within a corresponding supporting-member recess 230 in the bottom side 206 of the removable seat 200. In various aspects, the removable seat 200 may have a separate supporting-member recess for each supporting member, may have one supporting-member recess that accommodates a plurality of supporting members, or any variation between. As such, the supporting-member recess 230 may be generally shaped and sized for receiving any quantity of supporting members. In other examples, multiple supporting members may be stored in the same supporting-member recess or a single supporting-member recess may be configured to receive a plurality of the supporting members.

Although the example depicted in FIGS. 4A - 6B include a plurality of supporting members 400, it should be understood that some aspects may have only one supporting member, which may be more centrally located between the first side 216 and the second side 218, or more than two supporting members, which all may have similar features described with respect to the plurality of supporting members 400 described with respect to FIGS. 4A - 6B. Though the shape and size of the supporting members is depicted as similar, it will be understood from this disclosure that some portion of supporting members may be different or distinct from other support member(s) of the same removable seat 200. For example, the one or more supporting members discussed may comprise at least two supporting members that are each positioned in a separate recess in the bottom side when in the storage position, as shown in the examples.

The plurality of supporting members 400 may be held within the supporting-member recess 230 so that the plurality of supporting members 400 are flush with the bottom surface 210 of the removable seat 200. When in the storage position, this flush arrangement ensures that the plurality of supporting members 400 do not interfere with coupling the removable seat 200 to the support base 300 when the car seat 100 is in the first configuration.

As shown in the example of FIGS. 4A-B and 6A-B, each supporting member 400 is stored in a separate supporting-member recess 230, and each supporting member 400 may substantially fill a corresponding supporting-member recess 230 when in the storage position. As used herein, the term “substantially fill” may allow for a gap 231 to be formed adjacent to a distal end of a supporting member 400. As such, the gap 231 shown in FIGS. 6A-B may be sized to allow a user to grasp the distal end of the supporting member 400 with at least one finger to pivot the supporting member 400 out of the supporting-member recess 230 from the storage position and into the use configuration. The space between the distal end and the edge of the supporting-member recess 230 as it meets the bottom surface 210, where the gap 231 is positioned, may be within a range of about 10 millimeters to about 20 millimeters. In various aspects, the distal end of the supporting member 400 may have further form or have a divot, flange, or a groove 410. In such aspects, a user may insert their digits into the gap 231 and into the groove 410 to grasp the supporting member 400, and to move the supporting member 400 about the pivot point 402 from the storage position to the use configuration.

The supporting members 400 may be secured to the removable seat 200 at the pivot point 402, wherein the pivot point 402 is positioned in the rear of the supporting-member recess 230. In this way, moving the supporting members 400 from the storage position to the use position may include pivoting the supporting members 400 in the first direction 440, shown in FIGS. 5 and 6B, out of the corresponding supporting-member recess 230 and towards the rear end 214 of the removable seat 200.

In some aspects, the supporting members 400 may be slidably secured to the bottom side 206 of the removable seat 200 so that the supporting members 400 slide outward from the storage position and into the use position. In particular, the supporting members 400 may be slidably secured to the removable seat 200 adjacent the rear end 214 of the removable seat 200. As such, the supporting members 400 may support the rear end 214 of the removable seat 200 by sliding outward (either manually or using a mechanism) into a use position, thereby converting the car seat 100 from the first configuration to the second use configuration. Thus, although the aspects herein are discussed with regard to a pivoting motion and mechanism, other movements and translations of the supporting members 400 are contemplated and considered to be within the scope of this Description.

In the example depicted with a plurality of supporting members 400, there may be a supporting member 400 on each of the first bottom portion 226 and the second bottom portion 228 of the removable seat 200 and configured to be received within the supporting-member recess 230 in each of the first bottom portion 226 and the second bottom portion 228. When in the supporting-member recess 230, the supporting members 400 may be substantially aligned with the bottom surface 210 so that the removable seat 200 may remain generally flush with the first seat portion 326 and the second seat portion 328 of the support base 300 when the supporting members 400 are in the storage positon and the removable seat 200 is coupled to the support base 300. For example, each supporting member 400 may have a first surface 404 that is downward facing when in the storage position that may abut the first seat portion 236 or the second seat portion 328 when the removable seat 200 is coupled to the support base 300. Accordingly, a first surface 404 of each supporting member 400 abuts the support base 300 in the first configuration.

In the use configuration of the supporting members (which corresponds to the second configuration of the car seat 100), the supporting members 400 are configured to support the rear end 214 of the removable seat 200 by the direct contact of the second surface(s) 206 of the supporting members 400 with a vehicle seat, and the direct contact of the bottom surface 210 at the front end 212 with the vehicle seat. This stabilizes the removable seat 200. The second surface 406 may be on a different side or an opposite side from the first surface 404. When the supporting member 400 is in the storage position, this second surface 406 may be facing into the supporting-member recess 230 whereas the first surface 404 may be facing outward, as flush with the bottom surface 210.

One or more locking mechanisms may be used to maintain the supporting members 400 in the storage position and/or the use position. In the examples shown in FIGS. 6A and 6B, the one or more supporting members 400 may include a first storage locking structure 432 and a second use locking structure 434. The removable seat may include as third storage locking structure 232 and a fourth use locking structure 434, as discussed hereinafter.

The first storage locking structure is configured to configured to releasably couple to the third storage locking structure 232 on the removable seat 200 when the supporting member 400 is in the storage position. As such, the first storage locking structure 432 and the third storage locking structure 232 may be referred to as “storage” locking structures as contributing to retaining the corresponding supporting member 400 in a storage position. The first storage locking structure 432 may be a surface that forms a recess, groove, opening, channel, divot, or the like, and a lip 580 that contacts and releasably engage the third storage locking structure 232. The recess may be any shape, curvilinear, or comprised of planar surfaces, although shown as having a substantially planar surface for contacting the third storage locking structure 232. The third storage locking structure 232 may include one or more surfaces within the supporting-member recess 230 that form an edge and a terminal end projection, as shown in FIG. 6A and 6B. The lip 580 engages and overhangs the edge so as to “grasp” the edge of the third storage locking structure 232 when in the storage position. Further, the terminal end projection of the third storage locking structure 232 engages an interior apex of the recess of the first storage locking structure 432 when in the storage position, further securing the supporting member 400 within the supporting-member recess 230.

The first and third storage locking structures 432 and 232 may use a frictional engagement from the contact between their respective surfaces to maintain the supporting member 400 in the storage position, despite the gravitational pull downward. This prevents the supporting members 400 from swinging open under the force of gravity, and enables the removable seat 200 to the coupled to the support base 300 without the supporting members 400 swinging freely and obstructing the flush arrangement previously described hereinabove. This frictional engagement may be overcome by a particular force, such as a user pulling on the supporting member 400, to remove the supporting member 400 from the supporting-member recess 230.

Each supporting member 400 may include a second use locking structure 434 configured to releasably couple to a fourth use locking structure 234 on the removable seat 200 when the supporting member 400 is in the use position. As such, the second use locking structure 434 and the fourth use locking structure 234 may be referred to as “use” locking structures as contributing to the corresponding supporting member 400 being held and supported in the use position. The second use locking structure 434 may include one or more surfaces that form a recess groove, opening, channel, divot, or the like. The recess may be any shape, such as curvilinear or comprised of planar surfaces, although shown as having a substantially planar surface for contacting the fourth use locking structure 234. The fourth use locking structure 234 may include a projection, protrusion, flange, or hook having a terminal end that inserts into and engages the recess of the second use locking structure 434 when the supporting member 400 is in the use position. As shown in the example of FIG. 6B, a terminal end of the fourth use locking structure 234 is oriented and angled so as to contact and engage an apex of the recess formed by the second use locking structure 434. When weight is loaded (e.g., occupant placed into the removable seat 200) while the supporting members 400 are in the use position, the weight/load pushes the terminal end of the fourth use locking structure 234 into further contact so as to securely engage the apex of the recess formed by the second use locking structure 434. By engaging the apex of the recess when loaded, the terminal end “locks” into the apex further securing the supporting member 400 in the use position. Additional surface contacts, such as the surface 582 contacting 284 may bolster the strength of the frictional contacts and add additional rigidity or stability to supporting member in the use position.

The second use locking structure 434 and the fourth use locking structure 234 may use a frictional engagement from the contact between their respective surfaces to maintain the supporting member 400 in the use position, until the frictional engagement may be overcome by a force, such as a user pulling on the supporting member 400, to pivot the supporting member 400 in a second direction 441 that is different from and/or opposite to the first direction 440 in order to store the supporting members 400.

The second use locking structure 434 may be positioned on a particular surface or end or the supporting member 400 that is located elsewhere, or opposite relative to, the first storage locking structure 432. For example, when the supporting member 400 is pivoted from the storage to the use position, the locking structure that is being engaged changes. Thus, when the first storage locking structure 432 is engaged and the supporting member 400 is in a storage position, the second use locking structure 434 is not being engaged; and vice versa. Thus, the first storage locking structure 432 on the removable seat 200 may be positioned within the supporting-member recess 230 and the second use locking structure 434 on the removable seat 200 is positioned outside the recess, as positioned on opposite sides of the respective supporting member.

Based on the pivoting motion of the supporting member, the locking structures being engaged changes. The fourth use locking structure 234 is stationary and is positioned to be closer to the front end 212 than the pivot point 402. The third storage locking structure 232 is also stationary, in aspects. The third storage locking structure 232 is positioned to be closer to the rear end 214. Both the fourth use locking structure 234 and the third storage locking structure 232 are positioned within, proximate to, and/or adjacent to the supporting-member recess 230, in aspects.

Continuing to FIG. 6C, a cross-section of the car seat 100 is shown in the first configuration, wherein the supporting members 400 are not shown and are in a storage position, and the flush arrangement is visible. In FIG. 6C, one or more locking members 502 on one of the removable seat 200 (or the support base 300) are configured to releasably couple the removable seat 200 to the support base 300. The one or more locking members 502 of the removable seat 200 are depicted as engaging and coupling the removable seat 200 to the support base 300. In one example, the one or more locking members 502 may comprise hooks on the removable seat 200, while the support base 300 comprises a locking structure such that the one or more hooks on the removable seat are secured to the locking structure on the support base, in the first configuration. Said hooks may extend outward to protrude beyond the bottom surface 210 at the rear end 214 of the removable seat 200, for example, as also visible in FIGS. 5, and 6A-B. The locking members 502 are configured to releasably engage one or more openings 602 of a locking structure, referred to herein as a receiver plate, or plate 600, in the detailed magnifications depicted in FIGS. 8-10B, of the support base 300, when the car seat 100 is in the first configuration. As such, the receiver, such as plate 600, on the support base 300 may include one or more openings 602 through which the one or more locking members 502, such as hooks, at least partially extend to latch onto the locking structure.

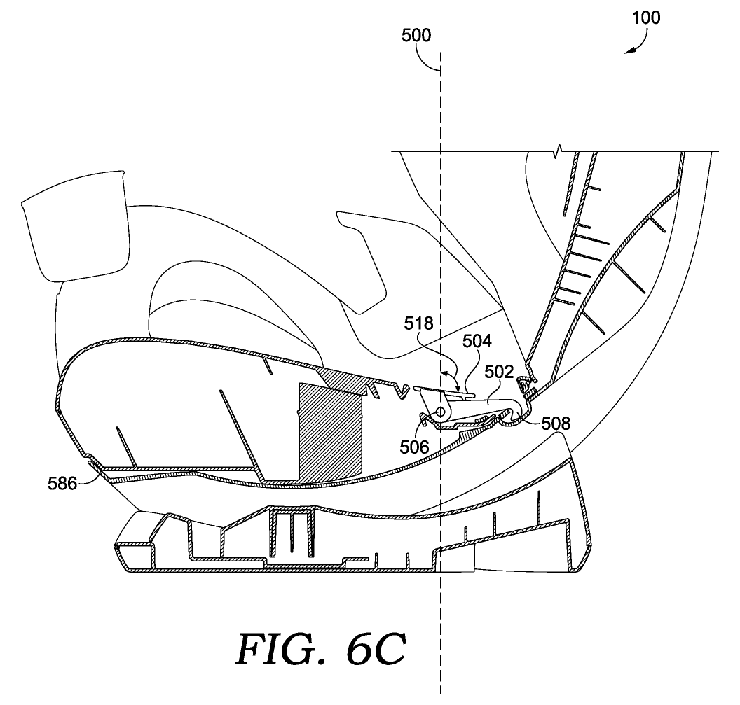

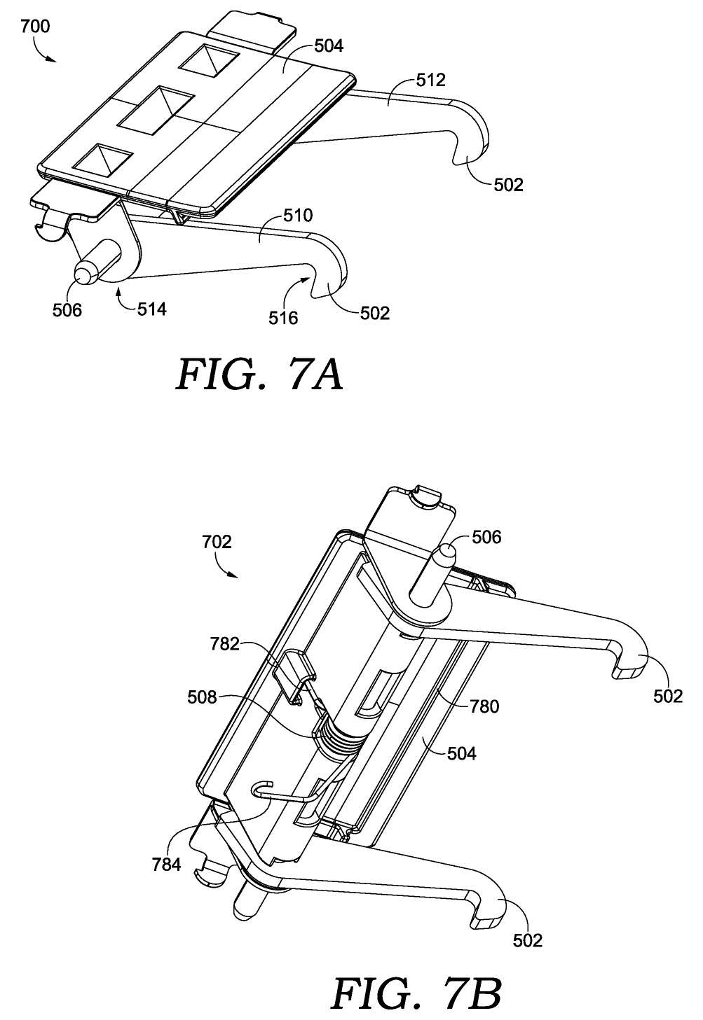

FIG. 7A depicts a top perspective view of the one or more locking members 502 and FIG. 7B depicts a bottom perspective view of the one or more locking members 502. An example mechanism for selectively coupling and uncoupling the removable seat 200 from the support base 300 is described with respect to FIGS. 7-10B. The one or more locking members 502 may include a first projection member 510 and a second projection member 512 that are parallel to each other, and terminally shaped to fit into and engage openings 602. In the example shown, each of the first and second projection members 510 and 512 have a terminal hook end 516. Each of the first and second projection members 510, 512 have terminal apertures through which a bar or arm 506 is horizontally inserted, thus coupling each of the first and second projection members 510 and 512 such that they are rotatable around at least a portion of the perimeter or circumference of the arm 506, to form a pivotable hinge 514. A tensioner, such as spring 508, is rotatably coupled to the arm 506 and to a pull 504 that is configured to be used as a handle for freeing the removable seat 200 from the support base 300. The pull 504 is rotatably coupled to the arm 506 as well. As visible in FIG. 7B, the each of the first and second projection members 510 and 512 and the pull may be tensioned by the spring 508, such that the first and second projection members 510 and 512 are pulled into contact with a ridge 780 that protrudes from the underside of the pull 504, which is depicted as substantially planar in this example. Thus, the first and second projection members 510 and 512 are tensioned to be pulled around the arm 506 and toward the pull 504, while the ridge 680 creates a gap that prevents the first and second projection members 510 and 512 from directly contacting an underside surface of the pull 504.

The substantially planar surface of the pull 504 is substantially aligned with and parallel to the top surface 211 of the removable seat 200, as shown in the example of FIG. 6C when the spring 508 in in a resting state. When the car seat 100 in in the first configuration and the spring 508 is in the resting state, the first and second projection members 510 and 512 are engaged with the openings 602 of the support base.

For example, the frame 604 may include a first frame structure 610 and a second frame structure 612 that are formed with strong, rigid, materials, such as steel and/or steel alloys. For example, the first frame structure 610 and the second frame structure 612 may have a maximum load threshold of at least 100 Kg. For example, the maximum load threshold may have a maximum load threshold of 150 kg. In order to reduce the weight, the first frame structure 610 and the second frame structure 612 may be configured, for example, as hollow tubular structures.

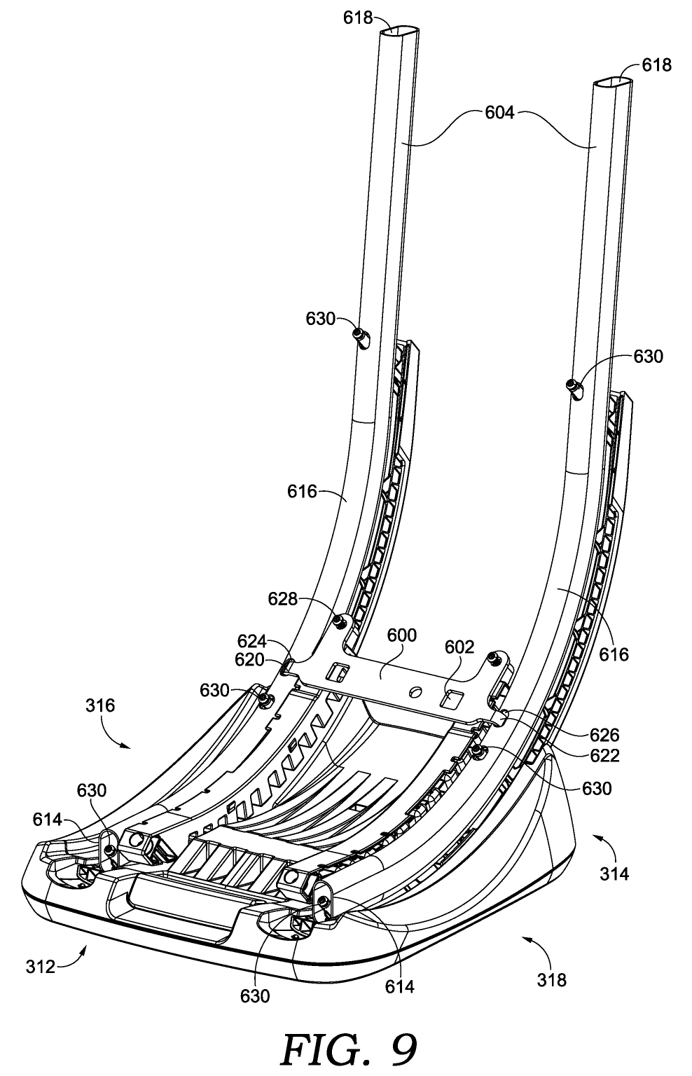

As shown in the perspective view of FIG. 9, a top side of a receiver/locking structure may be secured to the back portion 320 of the support base 300. For example, plate 600 may be secured to curved plate arms 606 that may extend though and into upward facing surface 616 of the frame 604 of the support base 300. For example, the first frame structure 610 and the second frame structure 612 may be spaced apart from one another, such that each of the first and second frame structures 610 and 611 extend from a front area of the seat portion 310 to a top area of the back portion 320, wherein a first end of the receiver/locking structure, such as plate 600, is secured to the first frame structure 610 and a second end of the receiver/locking structure such as plate 600, is secured to the second frame structure 612. The receiver/locking structure, in the example shown as plate 600, may be further secured in place with screws to be inserted and secured within the screw openings 608 (FIG. 8) and 628 (FIG. 9). By securing the plate 600 to the frame 604, the plate 600 is not jarred or moved when the removable seat 200 is removed and/or recoupled.

Further, to increase the stability of the support base 300, the frame 604 may be configured to extend continuously from a front end 312 toward a back portion 320. Specifically, each of the first frame structure 610 and the second frame structure 612 may have a first end 614 secured to the seat portion 310 of the support base 300 and a second end 618 secured to the back portion 320 of the support base 300. Particularly, each of the first frame structure 610 and the second frame structure 612 may be secured to the seat portion 310 of the support base 300 at one or more securement points 630; and at least one of the securement points 630 of the back portion 320 of the support base 300. As discussed briefly above, the first frame structure 610 has a slot or aperture 624 of an upward facing surface 616 to which a first hook 620 of the plate 600 is affixed, and the second frame structure 612 also has a slot or aperture 626 of an upward facing surface 616 to which a second hook 622 of the plate 600 is affixed. The first frame structure 610 and the second frame structure 612, as shown, run parallel to each other, which also improve the skeletal stability of the frame 604 for the support base 300.

When a force is applied to the pull 504 in the direction 518 toward a vertical reference axis 500, the pull 504 is repositioned to form a non-parallel and angled orientation relative to the top surface 211. For example, the gap that is created by the ridge 780 allows a user to slip their digits or other tool to the underside of the pull 504, and to apply force. The application of this “upward” force on the pull 504 enlarges the gap as the force is transferred to the spring 508. The movement of the pull 504 upward pushes the first end 782 of the spring 508 that is coupled to the pull 504 downward toward an upper surface that is adjacent the pylon 322, while the second end 784 of the spring 508 contacts the upper surface that is adjacent the pylon 322 of the support base 300. The upper surface of the support base 300 acts a passive upward force against the second end 784 while the pull 504 provides an active downward force to the first end 782. The tensioning of the first end 782 by the pull 504 and the tensioning of the second end 784 by the support base 300 is such that the spring 508 allows for the pull 504 to be lifted and the first and second projection members 510 and 512 to become disengaged from the openings 602.

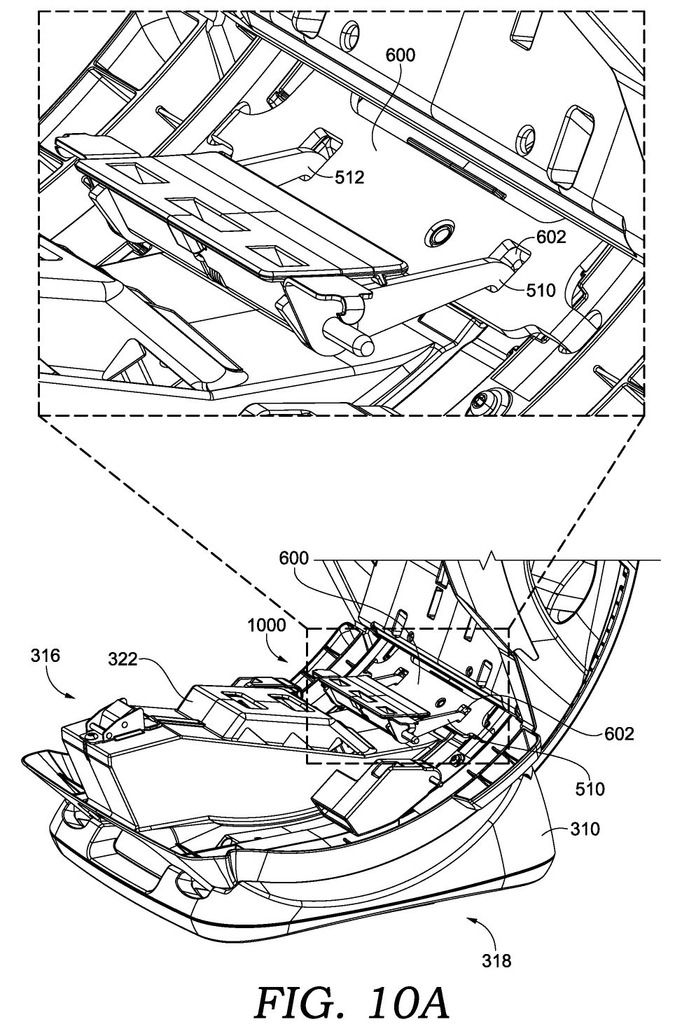

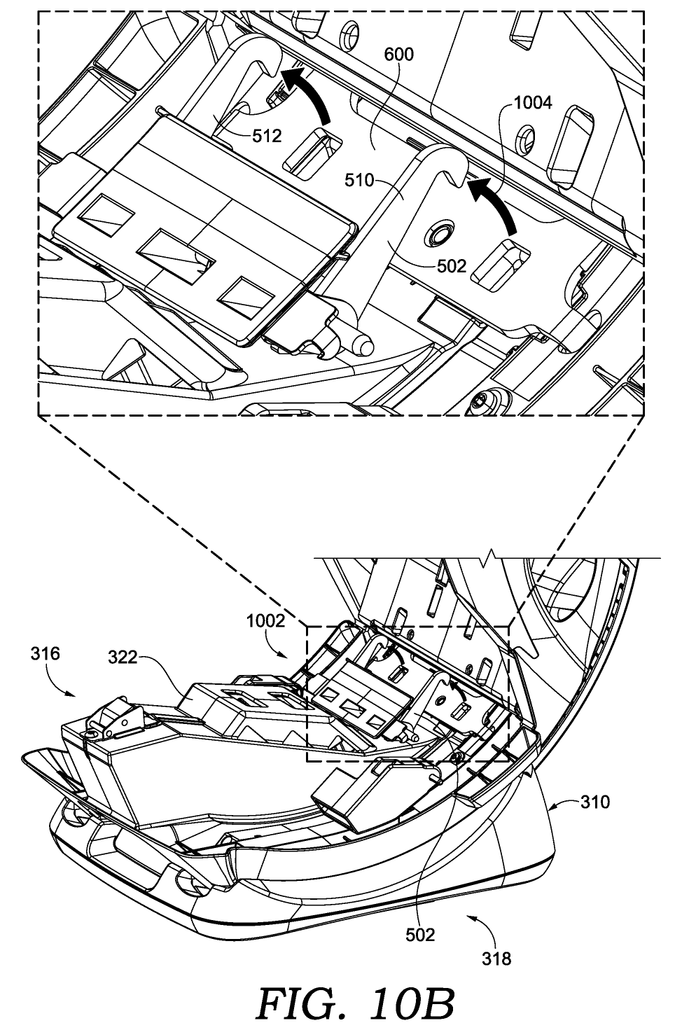

For example, FIGS. 10A and 10B depict the terminal ends of the first and second projection members 510 and 512 of the locking members 502 as separate from the removable seat 200 for visibility, including magnifications. The terminal ends of the first and second projection members 510 and 512 are inserted into and engaged with the openings 602 of the plate 600 as shown in FIG. 10A, such that the removable seat 200 may be coupled to the support base 300 with a flush arrangement. In FIG. 10A, the pull 504 is oriented such that an external force is not being applied, so that the pull 504 would be parallel to the top surface 211(not shown), as discussed above. In FIG. 10B, the pull 504 is oriented such that an external force is being applied, so that the pull 504 is angled relative to the top surface 211 (not shown). FIG. 10B depicts the terminal ends of the first and second projection members 510 and 512 of the locking members 502 disengaged and removed from the openings 602 of the plate 600.

The locking members 502 may, in one example, includes at least one hook that pivots from an engaged position to an disengaged position. The at least one hook pivots upward when moving from the engaged position to the disengaged position, in the example. In some instances, the locking members 502 may include a first hook 602 and second hook 622 extending parallel to each other. In such an example, each of the first hook 602 and the second hook 622 are secured to a receiver in the support base when the first hook and the second hook 622 are in the engaged position. When the hooks are in the engaged position, the hooks each extend rearward from a pivot point at an angle relative to a vertical reference plane at the pivot point, wherein the angle is no greater than 100 degrees. Then, each of the first hook 602 and second hook 622 pivot upward when moving from the engaged position when the removable seat 200 is in the first use configuration to the disengaged position to release the removable seat 200 from the support base 300.

As mentioned, the pull 504 may be used to decouple the removable seat 200 from the support base 300. When the user lets go of the pull 504 and the upward force is removed, the as-tensioned spring 508 automatically returns to a resting state, which returns the pull 504 from the angled state with respect to the top surface 211 to the substantially parallel state with respect to the top surface 211. Thus, the seating surface of the removable seat 200 returns to a comfortably shaped surface, as the pull 504 is again flush with the top surface 211. When the car seat 100 is in the second configuration, the locking members 502 are at least partially housed or recessed within the removable seat 200 such that the first and second projection members 510 and 512 extend outward, but do not extend beyond the farthest terminal end of the rear end 214 and thus, do not contact a vehicle seat back, as shown in FIGS. 6A-B. However, the first and second projection members 510 and 512 extend outwardly so that they can be inserted easily slotted into the openings 602, for engagement, to recouple the removable seat 200 to the support base 300, for the first configuration.

Clause 1. A child car seat comprising: a support base having a seat portion and a back portion extending upward from a rear end of the seat portion, the support base comprising a first frame structure and a second frame structure each extending from a front area of the seat portion to a top area of the back portion and a locking structure having a first end secured to the first frame structure and a second end attached to the second frame structure; and a removable seat that is releasably coupled to the support base, wherein in a first use configuration, the removable seat is coupled to the support base and is positioned on top of the seat portion of the support base, and wherein in a second use configuration, the removable seat is uncoupled from the support base and is configured to be positioned on a vehicle seat surface; wherein the removable seat comprises one or more locking members that releasably engage with the locking structure on the support base when the removable seat is in the first use configuration.

Clause 2. The child car seat of clause 1, wherein the one or more locking members of the removable seat comprise at least one hook that pivots from an engaged position to a disengaged position.

Clause 3. The child car seat of clauses 1-2, wherein the at least one hook pivots upward when moving from the engaged position to the disengaged position.

Clause 4. The child car seat of clauses 1-3, wherein the one or more locking members comprise a first hook and a second hook extending parallel to each other.

Clause 5. The child car seat of clauses 1-4, wherein the first frame structure and the second frame structure each comprise a tubular structure.

Clause 6. The child car seat of clauses 1-5, wherein the first frame structure and the second frame structure each comprise a steel tubular structure.

Clause 7. The child car seat of clauses 1-6, wherein the locking structure of the support base comprises at least one opening configured to receive the one or more locking members of the removable seat.

Clause 8. The child car seat of clauses 1-7, wherein a top side of the locking structure is secured to the back portion of the support base.

Clause 9. The child car seat of clauses 1-8, wherein the first end of the locking structure is attached to an upward-facing surface of the first frame structure and the second end of the locking structure is attached to an upward-facing surface of the second frame structure.

Clause 10. A child car seat comprising: a support base having a seat portion and a back portion extending upward from a rear end of the seat portion of the support base; and a removable seat that is releasably coupled to the support base, wherein in a first use configuration, the removable seat is coupled to the support base and is positioned on top of the seat portion of the support base, and wherein in a second use configuration, the removable seat is uncoupled from the support base and is configured to be positioned on a vehicle seat surface; wherein the removable seat comprises one or more hooks that each pivot upward when moving from an engaged position when the removable seat is in the first use configuration to a disengaged position to release the removable seat from the support base.

Clause 11. The child car seat of clause 10, wherein the one or more hooks comprise a first hook and a second hook extending parallel to each other.

Clause 12. The child car seat of clauses 10-11, wherein the first hook and the second hook are secured to a receiver in the support base when the first hook and the second hook are in the engaged position.

Clause 13. The child car seat of clauses 10-12, wherein the support base further comprises a first frame structure and a second frame structure each extending from a front area of the seat portion to a top area of the back portion of the support base; wherein a first end of the receiver is secured to the first frame structure and second end of the receiver is secured to the second frame structure.

Clause 14. The child car seat of clauses 10-13, wherein the receiver of the support base comprises a locking structure having at least one opening configured to receive the first hook and the second hook of the removable seat.

Clause 15. The child car seat of clauses 10-14, wherein the first end of the receiver is attached to an upward-facing surface of the first frame structure and the second end of the receiver is attached to an upward-facing surface of the second frame structure.

Clause 16. The child car seat of clauses 10-15, wherein when the one or more hooks are in the engaged position, the one or more hooks each extend rearward from a pivot point at an angle relative to a vertical reference plane at the pivot point, wherein the angle is no greater than 100 degrees.

Clause 17. A child car seat comprising: a support base having a seat portion and a back portion extending upward from a rear end of the seat portion of the support base; and a removable seat that is releasably coupled to the support base, wherein in a first use configuration, the removable seat is coupled to the support base and is positioned on top of the seat portion of the support base, and wherein in a second use configuration, the removable seat is uncoupled from the support base and is configured to be positioned on a vehicle seat surface; wherein the removable seat comprises one or more hooks that extend outward in a rearward direction from a pivot point on a bottom side of the removable seat, the one or more hooks pivot between engaged and disengaged positions to release the removable seat from the support base, wherein when the one or more hooks are in the engaged position, the one or more hooks each extend in the rearward direction at an angle relative to a vertical reference plane at the pivot point, wherein the angle is no greater than 100 degrees.

Clause 18. The child car seat of clause 17, wherein the support base further comprises: a first frame structure and a second frame structure each extending from a front area of the seat portion to a top area of the back portion of the support base; and a receiver to which the one or more hooks are secured when the removable seat is in the first use configuration, wherein a first end of the receiver is secured to the first frame structure and second end of the receiver is secured to the second frame structure.

Clause 19. The child car seat of clauses 17-18, wherein the one or more hooks comprise a first hook and a second hook extending parallel to each other, the first hook and the second hook each pivoting upward when moving from the engaged position to the disengaged position.

Clause 20. The child car seat of clauses 17-19, wherein the removable seat has a bottom surface extending from a front end of the removable seat to the rear end of the removable seat, wherein when the removable seat is in the first use configuration, the bottom surface of the removable seat at the rear end is positioned at least 5 centimeters superior to the bottom surface at the front end.

While particular exemplary aspects have been described, it is not intended that the claims be limited thereto, as it is intended that the claims be as broad in scope as the art will allow and that the specification be read likewise. That is, the foregoing description of specific aspects will so fully reveal the general nature of the disclosure that others may, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It will be appreciated by those of ordinary skill in the art that the components, method steps, and materials illustrated above may be varied by substitution of equivalent components, steps, and materials capable of performing the same functions. It will also be appreciated by one of ordinary skill in the art that sizes and strengths of the components may be scaled up or down as required for specific purposes. The claims hereof are intended to encompass all such equivalent components, method steps and scales.

What is claimed is:

1. A child car seat comprising:
a support base having a seat portion and a back portion extending upward from a rear end of the seat portion, the support base comprising a first frame structure and a second frame structure each extending from a front area of the seat portion to a top area of the back portion and a locking structure having a first end secured to the first frame structure and a second end attached to the second frame structure; and
a removable seat that is releasably coupled to the support base, wherein in a first use configuration, the removable seat is coupled to the support base and is positioned on top of the seat portion of the support base, and wherein in a second use configuration, the removable seat is uncoupled from the support base and is configured to be positioned on a vehicle seat surface;
wherein the removable seat comprises one or more locking members that releasably engage with the locking structure on the support base when the removable seat is in the first use configuration.

2. The child car seat of claim 1, wherein the one or more locking members of the removable seat comprise at least one hook that pivots from an engaged position to a disengaged position.

3. The child car seat of claim 2, wherein the at least one hook pivots upward when moving from the engaged position to the disengaged position.

4. The child car seat of claim 1, wherein the one or more locking members comprise a first hook and a second hook extending parallel to each other.

5. The child car seat of claim 1, wherein the first frame structure and the second frame structure each comprise a tubular structure.

6. The child car seat of claim 1, wherein the first frame structure and the second frame structure each comprise a steel tubular structure.

7. The child car seat of claim 1, wherein the locking structure of the support base comprises at least one opening configured to receive the one or more locking members of the removable seat.

8. The child car seat of claim 7, wherein a top side of the locking structure is secured to the back portion of the support base.

9. The child car seat of claim 1, wherein the first end of the locking structure is attached to an upward-facing surface of the first frame structure and the second end of the locking structure is attached to an upward-facing surface of the second frame structure.

10. A child car seat comprising:
a support base having a seat portion and a back portion extending upward from a rear end of the seat portion of the support base; and
a removable seat that is releasably coupled to the support base, wherein in a first use configuration, the removable seat is coupled to the support base and is positioned on top of the seat portion of the support base, and wherein in a second use configuration, the removable seat is uncoupled from the support base and is configured to be positioned on a vehicle seat surface;
wherein the removable seat comprises one or more hooks that each pivot upward when moving from an engaged position when the removable seat is in the first use configuration to a disengaged position to release the removable seat from the support base.

11. The child car seat of claim 10, wherein the one or more hooks comprise a first hook and a second hook extending parallel to each other.

12. The child car seat of claim 11, wherein the first hook and the second hook are secured to a receiver in the support base when the first hook and the second hook are in the engaged position.

13. The child car seat of claim 12, wherein the support base further comprises a first frame structure and a second frame structure each extending from a front area of the seat portion to a top area of the back portion of the support base; wherein a first end of the receiver is secured to the first frame structure and second end of the receiver is secured to the second frame structure.

14. The child car seat of claim 13, wherein the receiver of the support base comprises a locking structure having at least one opening configured to receive the first hook and the second hook of the removable seat.

15. The child car seat of claim 13, wherein the first end of the receiver is attached to an upward-facing surface of the first frame structure and the second end of the receiver is attached to an upward-facing surface of the second frame structure.

16. The child car seat of claim 10, wherein when the one or more hooks are in the engaged position, the one or more hooks each extend rearward from a pivot point at an angle relative to a vertical reference plane at the pivot point, wherein the angle is no greater than 100 degrees.

17. A child car seat comprising:
a support base having a seat portion and a back portion extending upward from a rear end of the seat portion of the support base; and
a removable seat that is releasably coupled to the support base, wherein in a first use configuration, the removable seat is coupled to the support base and is positioned on top of the seat portion of the support base, and wherein in a second use configuration, the removable seat is uncoupled from the support base and is configured to be positioned on a vehicle seat surface;
wherein the removable seat comprises one or more hooks that extend outward in a rearward direction from a pivot point on a bottom side of the removable seat, the one or more hooks pivot between engaged and disengaged positions to release the removable seat from the support base, wherein when the one or more hooks are in the engaged position, the one or more hooks each extend in the rearward direction at an angle relative to a vertical reference plane at the pivot point, wherein the angle is no greater than 100 degrees.

18. The child car seat of claim 17, wherein the support base further comprises:
a first frame structure and a second frame structure each extending from a front area of the seat portion to a top area of the back portion of the support base; and
a receiver to which the one or more hooks are secured when the removable seat is in the first use configuration, wherein a first end of the receiver is secured to the first frame structure and second end of the receiver is secured to the second frame structure.

19. The child car seat of claim 17, wherein the one or more hooks comprise a first hook and a second hook extending parallel to each other, the first hook and the second hook each pivoting upward when moving from the engaged position to the disengaged position.

20. The child car seat of claim 17, wherein the removable seat has a bottom surface extending from a front end of the removable seat to the rear end of the removable seat, wherein when the removable seat is in the first use configuration, the bottom surface of the removable seat at the rear end is positioned at least 5 centimeters superior to the bottom surface at the front end.
